(19) United States
(12) Patent Application Publication
(10) Pub. No.: US 2025/0348679 A1
(43) Pub. Date: Nov. 13, 2025

(54) METHOD, SERVER, AND SYSTEM OF MACHINE SOLVING MATHEMATICAL QUESTION

(71) Applicant: ASIA UNIVERSITY, Taichung (TW)

(72) Inventor: Wen-Lian Hsu, New Taipei City (TW)

(21) Appl. No.: 18/955,247

(22) Filed: Nov. 21, 2024

(30) Foreign Application Priority Data
May 10, 2024 (TW) 113117371

(51) Int. Cl. G06F 40/289

(52) U.S. Cl. CPC G06F 40/289

(57) ABSTRACT

A method of machine solving mathematical question is provided. The method comprises receiving a mathematical question described in a natural language; decomposing the mathematical question into multiple sentences, wherein the multiple sentences include one question sentence; establishing a relationship map of formula according to the relations of the one or more variables included each of the sentences; and calculating, sequentially, values of the one or more variables according to the relationship map of formula until a value of the variable included in the formula of the question sentence is calculated as an answer.

### CROSS REFERENCE TO RELATED PATENT APPLICATION

This patent application is based on a Taiwan, R.O.C. patent application No. 113117371 filed on May 10, 2024.

### FIELD OF THE INVENTION

The present invention relates to artificial intelligence (AI), and more particularly, to AI for machine solving mathematical question by utilizing natural language processing.

### BACKGROUND OF THE INVENTION

Natural language processing techniques have been progressed a long way after LLMs (large language models) are introduced. In the perspective of writing new articles, LLM can generate new paragraphs based on related materials among a large amount of training corpus. However, in the perspective of answering mathematical questions which have exact answers, LLM cannot understand the input mathematical questions based on the large amounts of training corpus, let alone reasoning and solving.

Hence, there exists a need of an automatic solving and interpretating system for mathematical questions. It is hoped that an explainable and reliable method can be designed. The point is how to interpret the text questions by a series of analysis, reasoning, and feeding of common senses into formulas and to calculate the answer according to the formulas. After that, it is also required to provide interpretations by goal-oriented ways and produces interactive and personalized test system.

### SUMMARY OF THE INVENTION

According to an embodiment of the present application, a method of machine solving mathematical question is provided. The method is applicable to a server. The method comprises: receiving a mathematical question described in a natural language; decomposing the mathematical question into multiple sentences, wherein the multiple sentences include one question sentence; determining whether each of the sentences is a formula sentence based on whether it includes a noun subject; converting each of the formula sentences into a corresponding formula, respectively, wherein each of the formulas includes one or more variables and one or more relations of the one or more variables, respectively; establishing a formula relationship map according to the one or more relations of the one or more variables included each of the formulas; and calculating, sequentially, values of the one or more variables according to the formula relationship map until a value of the variable included in the formula of the question sentence is calculated as an answer.

Preferably, in order to automatic error detection, the method further comprises determining whether each of the formulas is satisfied according to the value of the variables included in the formula relationship map; and determining the answer is wrong when at least one of the formulas is no satisfied.

Preferably, in order to heuristically teaching, the method further comprises generating a corresponding question sentence and its answer according to the variable and its value included in each of the formulas; and interacting with a student via an input device and an output device of the server according to the corresponding question sentences and the answers.

Preferably, in order to cope with the mathematical question with one or more graph, the method further comprises performing image and character recognition to a graph of the mathematical question to generate one or more sentences for describing the graph in the natural language.

Preferably, in order to avoid error in solving due to missing formula, the method further comprises, before the converting, expanding a simplified one of the formula sentences to a plurality of formula sentences.

Preferably, in order to avoid error in converting the formula sentences into formulas such that the standard structure can be correctly mapped into the formula pattern, the method further comprises, before the converting, organizing one of the formula sentences into a standard structure, which includes a subject, a verb, and an object.

Preferably, in order to avoid error in converting the formula sentences into formulas such that the standard structure can be correctly mapped into the formula pattern, the method further comprises, before the converting, refilling an omitted part in one of the formula sentences.

Preferably, in order to avoid error in converting the formula sentences into formulas, the method further comprises, before the converting, inferencing a noun referred by a demonstrative pronoun in one of the formula sentences.

Preferably, in order to make use of well-known correspondences between the formula sentences and the formulas, the converting further comprises looking up one of sentence types corresponding to one of the formula sentences in a database, wherein the database includes information of the sentence types; and composing the corresponding formula based on a quantity and a variable in the one of the formula sentences according to a formula pattern corresponding to the one of the sentence types corresponding to the one of the formula sentences.

Preferably, in order to make use of well-known correspondences between the formula sentences and one or more entailment formulas, the converting further comprises composing the corresponding formula based on the quantity and the variable implicitly denoted in the one of the formula sentences according to an entailment formula pattern corresponding to the one of the sentence types corresponding to the one of the formula sentences.

Preferably, in order to cope with ever changing expressions of sentences, the method further comprises classifying the one of the formula sentences according to a trained neural network model for looking up the one of the sentence types corresponding to the one of the formula sentences.

Preferably, in order to take advantage of hidden knowledge and to avoid missing formula, the converting further comprises inferencing semantically one of the formula sentences according to a knowledge map; and composing the corresponding formula based on a quantity included in the one of the formula sentences and a hidden variable inferenced semantically.

Preferably, Preferably, in order to cope with ever changing expressions of sentences, the method further comprises classifying the one of the formula sentences according to a trained neural network model for finding out a question type of the one of the formula sentences to get an implicit formula and the hidden variable corresponding to the question type.

Preferably, in order to make relationships between formulas, the establishing further comprises unifying all of the variables with same essence to reduce a quantity of variables; and connecting nodes of the formula relationship map with an edge referred to a common one of the variables, wherein the connected nodes are corresponding to the formula sentences including the common one of the variables, respectively.

Preferably, in order to solving mathematical question with chained equations, the calculating further comprises finding out one or more peripheral formulas of the formula relationship map, wherein the value of the variable corresponding to the peripheral formula is known; and recursively calculating the value of the variable of the formula adjacent to the formula including the calculated value of the variable.

Preferably, in order to solving mathematical question with simultaneous equations, the calculating further comprises, after the recursively calculating, when at least one value of the variables included in the formula relationship map is unknown, performing a step of variable elimination to solve simultaneous equations to calculate all values of the variables included in the relationship map of formula.

According to one embodiment of the present application, a server of machine solving mathematical question is provided. The server comprises a processor configured for executing multiple instructions stored in a non-volatile memory to fulfill the method recited above.

Preferably, in order to perform machine solving in a single machine, the server further comprises an input device for receiving the mathematical question; and an output device for outputting the answer.

Preferably, in order to perform machine solving in a network environment, a system of machine solving mathematical question is provided according to an embodiment of the present application. The system comprises the server as recited above; and a user computer, configured for transmitting the mathematical question to the server via a network and for receiving the answer from the server via the network.

In summarized, the present application provides a method of machine solving mathematical questions and providing explanations. It is different from blind guess works of traditional large natural language model based on learned materials. The method provided by the present application is explainable and reliable. The inventive points include a series of analysis and inferences of the mathematical questions, inputs of common senses, interpretations of formulas, and the calculations of final answers. After the calculations, explanations are provided in goal-oriented ways and interactive and personalized test system is generated accordingly. With the growth of question types and sentence types of the knowledge map, the method of solving mathematical questions by machine and providing explanations provided by the present application can expand the scopes of solvable questions. While the expansion of solvable questions, the method still can generate a series of question sentences and corresponding answers based on the solving process of the mathematical question, such that students can learn the solving process through the series of question sentences and corresponding answers.

### BRIEF DESCRIPTION OF THE DRAWINGS

The advantages and spirit related to the present invention can be further understood via the following detailed description and drawings.

FIG. 1 is a block diagram shows a natural language understanding and solving system 100 in accordance with an embodiment of the present application.

FIG. 2 is a block diagram depicts a server 110 in accordance with an embodiment of the present application.

FIG. 3 is a block diagram illustrates a user computer 130 in accordance with an embodiment of the present application.

FIG. 4 is a flowchart diagram shows a method of solving mathematical question by machine in accordance with an embodiment of the present application.

FIG. 5 is a flowchart diagram depicts a method of converting a sentence into a corresponding formula in accordance with an embodiment of the present application.

FIG. 6 is a flowchart diagram illustrates a method of solving mathematical question based on a relationship map of formula in accordance with an embodiment of the present application.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

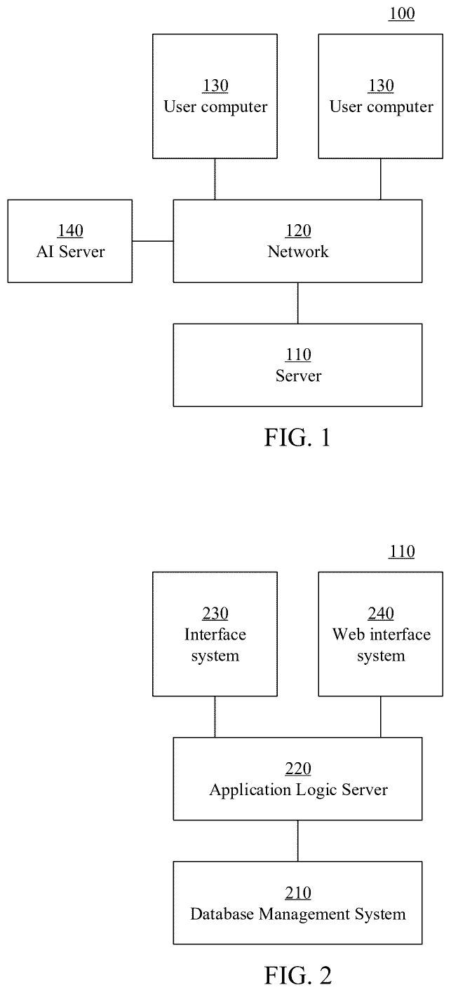

Please refer to FIG. 1, which depicts a natural language understanding and solving system 100 in accordance with an embodiment of the present application. The natural language understanding and solving system 100 comprises a server 110, a network 120, and user computers 130. The network may be a combination of one or more physical networks which may include one or more interconnected WANs (wide area networks) or telecommunication networks and one or more access networks or LANs (local area networks) connected with the WANs or telecommunication networks. The WAN or telecommunication network may be a wired or wireless network provided by telecommunication operators. For examples, they may be Internet, wireless mobile networks compliant with 3G/4G/5G/6G standard, Starlink™ or Iridium™ satellite communication networks. The access networks or LANs may be wired or wireless local area network, such as wired network compliant with IEEE 802.3 series standards or wireless network compliant with IEEE 802.11 series standards. The network 120 may be used to deliver information in between the server 110 and user computers 130.

Please refer to FIG. 2, which is a block diagram depicts a server 110 in accordance with an embodiment of the present application. The server 110 may include a combination of one or more physical or logic computers. For example, it may be a server composed of virtual machines executed in one or more physical computers. From the perspective of software function, the server 110 may comprise a DBMS (database management system) 210, an application/Logic serving system 220, an interface system 230, and a web interface system 240.

The DBMS 210 may include relational DBMS, such as common seen MySQL, Oracle, DB2 or non-relational DBMS or even simple spreadsheet system. It is used to store questions, histories of questions, user information, course progress etc. information related to the natural language understanding and solving system 100.

The application/logic serving system 220 may include common seen application server and/or business logic system. For example, Oracle's J2EE server and Microsoft's ASP.NET server. The application/logic serving system 220 may comprise AI (artificial intelligence) models and their inference modules, such as various trained neural network models. The application/logic serving system 220 may implement various application programs or business logics which utilize the data stored in the DBMS 210 and communicate with the user computers 130 via the interface 230 and/or the web interface system 240. For examples, Enterprise JavaBeans and ASP programs may be configured to fulfill the methods and steps provided by the present application to manipulate the data stored in the DBMS 210.

The interface system 230 may comprise proprietary and/or compliant with industry standards protocols system for communicating with the applications installed in the user computers 130. The web interface system 240 may use HTTP, HTTPS, HTML series protocol to communicate with the web browsers installed in the user computers 130. For example, Apache Web Server is widely adopted.

The present application does not limit the software realized by the server 110 has to be formed in the three-tier architecture. The software may be constructed as a single tailored made software package. However, person having ordinary skill in the art can understand that the server 110 provided by the present application includes a capability to connect with the network 120, ability to fulfill the methods and steps provided by the present application, and ability to store related information.

In one embodiment, the natural language understanding and solving system 100 may comprises a AI server 140 for providing natural language processing capabilities in order to deal with the content generation of teaching instructions. The AI server 140 may be configured for realizing a natural language processing model, such as a LLM (large language model). For examples, OpenAI's ChatGPT, Google's Gemini, Meta's LLAMA models. Persons having ordinary skill in the art can understand the AI inference mentioned in the present application can be handled based on computing resources provided by the server 110 or by the AI server 140.

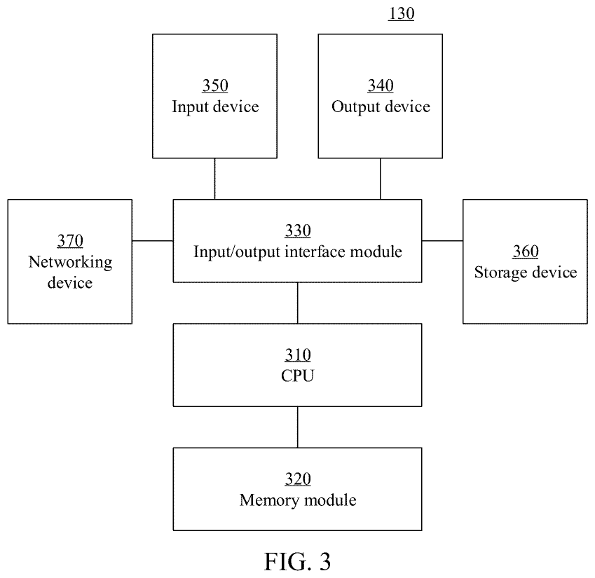

Please refer to FIG. 3, which is a block diagram illustrates a user computer 130 in accordance with an embodiment of the present application. The user computers 130 may be wearable mobile device, smartphone, personal digital assistant, tablet computer, laptop computer, desktop computer, or any other types of computers. For examples, the user computers 130 may be von Neummanb architecture or its variants of computers.

The user computer 130 may comprise a central processing unit 310, a memory module 320, an input/output interface module 330, an output device 340, an input device 350, a storage device 360 and/or a network device 370. The central processing unit 310 comprises at least one microprocessor, for example, the microprocessor, adapted to RISC-V, x86, x64, ARM, alpha etc. instruction set, is configured to execute instructions stored in the memory module 320, in order to control the user computer 130 via operating system and/or application programs software. Thus, the user computer 130 may use operating system and/or application programs software to control hardware to realize the methods and steps provided by the present application.

The input/output interface module 330 may be proprietary or compliant with industry standards interface, for examples, USB series, SATA series, SCSI series, PCI series, PCI-Express series etc. interfaces, for connecting with the output device 340, the input device 350, the storage device 360 and/or the network device 370. The output device 340 is configured to output data out of the user computer 130. For examples, outputting sounds, images, data etc. types of signals. Common seen output device 340 comprises display, speaker, and printer etc. The input device 350 is configured to input data into the user computer 130. Common seen input device 350 comprises touchpad, touch screen, keyboard, mouse, microphone, camera, satellite positioning device, and 2D or 3D scanners etc. The storage device 360 comprises nonvolatile memory, for examples hard drive disk, flash memory, optical disk, and magnetic disk etc. memory device. The network device 370 is configured to connect to the network 120, for example, connecting to an access network included in the network 120.

In one embodiment, the network device 370 is capable to determine the location of the user computer 130 according to locations of the connected routers and wireless base stations. Besides, the wireless or satellite communication network operators may triangulate the location of the network device 370 according to the emitted radio frequency waves by multiple base stations or satellites. The location of the user computer 130 can be transmitted to the user computer 130 via LBS (location-based service).

The storage device 360 is configured to store the operating system and application programs which are used to realize the methods and steps provided by the present application. In one embodiment, the user can communicate with the server 110 via the common use or proprietary web browser installed in the user computer 130 and the web interface system 240 of the server 110. In an alternative embodiment, the user can communicate with the server 110 via a dedicated application program installed in the user computer 130 and the interface system 230. Person having ordinary skill in the art can understand that when a part or all of the methods or steps provided by the present application must be performed by the user computer 130, they can be realized by the browser executing the web programs (e.g., HTML5 Java Bytecode, ASP, and java scrip etc.) provided by the server 110. They can be also realized by the application program installed in the user computer 130 executing instructions according to instruction and/or data provided by the server 110.

Person having ordinary skill in the art can understand that although the block diagram as shown in FIG. 3 is an embodiment of the user computer 130, the block diagram may be also an embodiment of the server 110 as shown in FIG. 1. The server 100 may comprises CPU, network device, and memory module etc. devices to fulfill the methods and steps provided by the present application. The storage device included in the server 110 may be used to store the deep neural network models, knowledge map, and database etc. which are used in the present application.

The natural language understanding and solving system 100 may be configured to realize the natural language understanding and solving method provided by the present application. The natural language understanding and solving method may comprise a dialogue window shown by the user computer 130. The dialogue window may be a part of a dedicated application program or a part of a browser window. In some cases, the dialogue window may be a part of instant messaging software. The present application does not limit how to implement the dialogue window.

The user can input text and optional graph of mathematical question via the user computer 130. The mathematical question is transmitted to the server 110 via the network 120. Thus, the natural language understanding and solving method provided by the present application is realized by the server executing software. The mathematical question described in a natural language comprises a question sentence. In some embodiments, a mathematical formula may be also included in the question. The examples provided by the present application are elementary school level questions because this type of questions has standard answers. However, persons having ordinary skill in the art can understand that the present application does not limit to that.

The analysis of text questions inevitably involves natural language understanding. The natural language used in the mathematical course of elementary school level is not quite complicated than normal natural language used. However, it still has some classical difficulties of understanding such as omissions, demonstrative pronouns, common senses processing (not described in the context but well-known) and utilization of mathematical knowledge (when to apply addition, subtraction, multiplication, and division operations.) Operations of natural language understanding provided by the present application may be applied to normal natural language understanding. Expression of human's knowledge is based on an ontology architecture. With respect to a main concept, a category, a property, and an event of this main concept would be documented. It can be further expanded by including some related events in common senses.

Firstly, through sentence pattern parsing, elements of the sentence such as proper noun (names of person, institute, location), subject, verb, and subjects are analyzed. Because there may be omissions or inversions, the natural language understanding and solving method provided the present application occasionally has to deal with incomplete or informal sentences. Hence, at first it may need to regulate the sentence for deleting noises. After that, a classification is performed in order to simplify the process.

Contents of the natural language understanding and solving may be classified into six elements: 1. sentence standardization; 2. formula sentence handling; 3. answer calculations; 4. explanation generation; 5. automatic error detection; and 6. knowledge map.

### 1. Sentence Standardization

Because many sentences omit aforementioned concepts, for the convenience of sentence classification, the natural language understanding and solving method provided by the present application may refill the omitted concepts into the sentences. Besides, if in a sentence, two objects related to two or more numbers, the description would be simplified.

In one embodiment, if an input sentence is normal and standard, it does not need to perform standardization step on this sentence. In an alternative embodiment, if an input sentence is not normal and standard, one of following sentence standardization steps may be performed according to the input sentence.

### Standardization of Description Sequence in the Sentence

Standardization of description sequence of SVO (subject, verb, and object) in the sentence. For example:
What the teacher drank is two cups of juice.→The teacher drank two cups of juice.
What the teacher bought is two apples.→The teacher bought two apples.
These two apples you bought are sweet.→You bought these two apples which are sweet.

### Refill the Omission

Sentences often omit afore mentioned concepts. By looking backward, it needs to determine the name of omitted object according to the quantifier of the object or to determine the omitted noun according to the subject or the noun of location correspond to the verb. For example:

The father has two apples and eats three.→The father has two apples, and the father eats three apples.

Sometimes the verb may be omitted. For examples:
The teacher drinks two cups of juice and the student three.→The teacher drinks two cups of juice and the student drinks three cups of juice.

### Simplification of Sentence

Hsiaoming buys two apples and three pineapples.→Hsiaoming buys two apples and Hsiaomin buys three pineapples.
Hsiaoming buys apples and pineapples each two.→Hsiaoming buys two apples and Hsiaoming buys two pineapples.

However, in some sentences, relational descriptions about two or more objects are included, e.g., a comparison. In these cases, the natural language and solving method provided by the present application would preserve the original description. For example, the number of Hsiaoming's apples are three more than the number of Hsiaohwa's pineapples.

Usually, in a question, when a noun is quantified with a quantity, e.g., three boys, the number related to the noun is very likely being presented in a formula according to the natural language understanding and solving method provided by the present application. The noun, “boy” is referred to as the “noun object” or simply “object” in the present application. Besides, some nouns may be implicitly, e.g., time or age. For examples, in the question, it may state that it is X o'clock and Y or someone is Z year-old, where X, Y, Z are integers, respectively. That represents the nouns are already presented without specifically addressed. The sentences having the kinds of noun objects and their related numbers are called “formula sentences.” It means that the description of the formula sentence can be converted to a formula for calculation.

If a sentence does not include any number of noun objects at all but a description of question's environment, this sentence may be referred to as “scene sentence” in the present application. Most of them cannot be converted to formulas. For examples, it is dry recently, the water level of reservoir drops or Hsiaoming's apple is sweet.

### 2. Formula Sentence Handling

The objective of this step is to convert each of formula sentence into corresponding formula. During the conversion, a divide and conquer strategy is applied by classifying the formula sentence. Based on the transfer of objects, the step categories the verbs into several types. When different types of formula sentences being converted, the handling of the verbs may be slightly different.

### Types of Formula Sentences

If a mathematical formula is included in the mathematical questions, it does not need to convert the mathematical formula into another mathematical formula.

The formula sentences may be categorized into server types according to whether a quantity of an object is changed, a relation between an object and its property, or different units of object packages. In one example of the present application, the formula sentences of elementary school level mathematics course may be categorized into more than thirty types. Five examples are enumerated in following:
2.1. Type “have”. It is used to describe that someone has a quantity of objects or there is a quantity of objects in somewhere. For examples, Hsiaoming has three apples, there are four birds in the tree.
2.2. Type “quantity change”. The number of objects is changed (increased or decreased, related to the verb. For examples, the father buys 8 apples. Hsiaoming eats two apples.
2.3. Type “unit quantity”. It is used to describe a relation between an object and its property. For examples, five bags of rice are weighed ten kilograms, 100 dollars per ten comic books. The former describes a weight of a bag of rice. The later describes a unit price of a comic book.
2.4. Type “unit conversion”. It is used to describe different units of same object package. For examples, three chops in a bag of chocolate; 1 US dollar for 32 New Taiwan dollars; and there are three feet in a yard.
2.5. Type “left”. It is used to described someone's objects are decreased. For example, Hsiaoming ate one apple. How many apples does he has? Normally, the decrease of objects is defined by an aforementioned verb.

The classification of types of formula sentences may be achieved by deep machine learning and corrected by a parser. The present application does not limit the quantity of types of formula sentences. As long as the quantity and property of noun objects and/or relations to other noun objects and their variations are described in the sentences, the sentences can be converted into formulas.

### Formulas Corresponding to the Formula Sentences, Respectively

For each type of formula sentences, a corresponding formula is designed. According to the parser and deep machine learning, the natural language understanding and solving method provided by the present application can induce a formula pattern for each type of formula sentences. Based on the formula patterns, a corresponding quantity can be retrieved from the formula sentence into a predetermined formula.

### Basic Operation Framework (the Generation of Formulas)

Each operation of addition, subtraction, multiplication, and division has its own operation framework. These operations are also formed by inferences based on domain knowledge.
2.6. sentence pattern of Type “have”

S has X apples. The formula is following:
The number of apples owned by S=X
2.7 sentence pattern of Type “quantity change”

With regard to a same object, if the quantity of this object changes in the sentence. The number of variation (may be increased or decreased) is referred to as a quantity of change. The original number is referred to as “original” X1. The quantity of change is referred to as X2. The number after change is referred to as “current” X3. Assuming the change is an increase, the formula is represented as

$$“ original ” + “ quantity of change ” = “ current ” , or X 1 + X 2 = X 3$$

where X1, X2, and X3 are positive, respectively.

When it is asked for the “current”, an addition operation is performed based on X3=X1+X2.

When it is asked for the “original”, a subtraction operation is performed based on X1=X3−X2.

When it is asked for the “quantity of change”, a subtraction operation is performed based on X2=X3−X1.

In some circumstances, the sentence implies that the quantity of change is a negative value. For examples, 4 dollars are left. It means the “original” is more. After an action (a verb), some (X2) is consumed. Here, the quantity of change is decreased. Therefore, the formula of the example can be represented as X1−X2=4.
2.8 sentence pattern of Type “unit quantity”

X1 comic books cost X2 dollars. The formula is represented as follows:

$$a unit price of comic book X 3 ( dollar per book ) = X 2 ( dollars ) / X 1 ( books )$$

$$X 2 ( dollars ) = X 3 ( dollar per book ) \times X 1 ( books )$$

$$X 1 ( books ) = X 2 ( dollars ) / X 3 ( dollar per book )$$

### Common Senses of Entailment

Some sentences have many meanings. Several examples are given below.

Example 1: The father bought 5 apples.

Besides the literal meaning, two more entailments are listed:
A. The father has five more apples.
B. The father paid money for these five apples.

Normally, the sentences may be converted into the following formula.

Subject S bought X objects O.

Formula: the number of objects bought by the subject S=X

### Common Senses of the Entailments

A. The subject S has X more objects O.

Formula: the current number of objects O owned by the subject S=the original number of objects O owned by the subject S +X
B. The subject S paid money for X subjects

Formula: the money paid by the subject S=X multiplies a unit price of the object O.

Formula: the current money owned by the subject S=the original money owned by the subject S−the money paid by the subject S.

These kinds of entailment sentences may be denoted in a related event corresponding to the event <S, buy, O> in the ontology.

Different kinds of formula sentences may be applied to answer different questions:
C. How many objects O did S buy?
D. How many objects O did S have?
E. How much did S pay?
F. How much did S still have?

Example 2: Hsiaoming gave Hsiaohwa three apples.
A. Hsiaoming has three less apples.
B. Hsiaohwa has three additional apples.

The entailment sentences are highly related to their verbs. The natural language understanding and solving method provided by the present application has to clarify the relationships between the verbs and the objects.

In addition to the identification of various kinds of entities or labels and the entailments, sematic inferences are extremely important in mathematics. By utilizing the inferences, the natural language understanding and solving method provided by the present application may derivate important relationships between variables as well as the formulas generated according to the relationships which are not explicitly mentioned in the sentences. The inferences may be considered as part of common sense; and they are not explicitly written in context. Many questions would be difficult to be solved without the inferences.

Example 3: Hsiaoming is short of 200 dollars.

“Short” or insufficiency is corresponding to a certain number X1 to be tackled. It may be assumed that Hsiaoming currently owns X2 dollars.

$$Formula : X 1 - 200 = X 2.$$

Example 4: one person has X cups.

It may be considered as X cups assigned to one person (unit amount.)

It is supposed that there are X1 cups to be assigned to X2 persons.

$$Formula : X 1 cups / X 2 persons = X cups / person$$

Example 5: buy X1 O get X2 O free

It is assumed that the original unit price of O is X3 dollars.

$$Formula : Real unit price = ( X 1 multiplies X 3 ) dollars / ( X 1 + X 2 ) units$$

### Demonstrative Pronoun

Most demonstrative pronouns in mathematical questions are usually persons. In cases the number of objects the characters own changes, most of this kind of persons need to be considered. The natural language understanding and solving method provided by the present application may look backward to determine which person the demonstrative pronoun corresponds to according to the changes of object number the persons own. For examples.

In case the Father gives Hsiaoming 200 dollars, “he” will have enough money to buy a bicycle.→In case the Father gives Hsiaoming 200 dollars, Hsiaoming will have enough money to buy a bicycle.

“Will enough” implies insufficiency originally, but it becomes sufficiency after the money increased. Because money amounts of two persons both changes in the former sentence, the demonstrative pronoun, he, is corresponding to the person who has increased money according to the semantic inference.

### Question Sentence Processing

Comprehension of the question sentence has decisive influence on the question solving. First, the question sentence determines the last operation of the mathematical question is which one of the addition, subtraction, multiplication, division, or equivalence. After the last operation is determined, the question sentence may be reduced to a secondary question sentence for solving values of every operand. Analogously, it may determine the last operation of each secondary question sentence is which one of the addition, subtraction, multiplication, division, or equivalence. The analysis can be recursively done.

In case a question sentence involves values of multiple variables, the natural language understanding and solving method provided by the present application can simplify the compound question sentence. Each of the compound question sentence Q may be divided into multiple Sub-Questions (SQs), each of the Sub-Questions contains only one variable. For example, in case the question sentence is “how many apples do A and B own?” It can be divided into Sub-Question (1): “how many apples (X1) does A own?” and Sub-Question (2): “how many apples (X2) does B own?” The answer is X3 (=X1+X2). Each follow steps may be configured to calculate the answer to its corresponding Sub-Question. For each Sub-Question, a relevant sentence having identical SVO (subject, verb, and object) is selected among the previous sentences in order to form a mathematical question with less interfering sentences. This step is especially important for solving so-called “attainment” questions.

### Selection of Relevant Sentence

For a question sentence, the natural language understanding and solving method provided by the present application can select a condition sentence having identical SVO (subject, verb, and object) and a related event of the ontology, e.g., an entailment or an inference, among the previous sentences. This step is similar to deal with questions to reading comprehension. The selected condition sentence and the question sentence form a simpler mathematical question with less interfering condition sentences.

### Formulas in Application Questions

Application questions in elementary school mathematical courses correspond to specific types of questions, such as river current question, speed question, clock question, street light question. These specific types of questions correspond to their own existing formulas, respectively. For example, the river current question corresponds to following formulars:

$$downstream speed = boat speed + river current speed , and$$

$$upstream speed = boat speed - river current speed .$$

More importantly, the question sentence may ask to determine one of the boat speed value, the value of river current speed, or the value of traveling distance. Hence, natural language understanding and solving method provided by the present application can use a solution for normal questions with condition sentences corresponding to formulas to solve these application questions.

### 3. Calculations of Answer

### Formula Relation Map

A variable in a sentence and another variable in another sentence may have same meaning. In this case, the natural language understanding and solving method provided by the present application may replace the variable assigned to a smaller number by another variable assigned to a larger number. This process is referred to as variable reduction. The natural language understanding and solving method provided by the present application may establish a formula relation map based on formulas after the variable reduction process. Nodes of this formula relation map represents formulas. In case two formulas share a common variable, there exists a relation between these two formulas. The two nodes corresponding to these two formulas are connected by an edge corresponding to the common variable. By analyzing the mathematical question, each formula includes one or more variable. A formula with single one variable represents the value of the single one variable, e.g., X1=2. Meanwhile, the number of edges between two formula nodes may be more than one. For example, a first node representing a first formula (X1+X2=3) and a second node representing a second formula (X1−X2+X3=5) are connected by two edges, which are corresponding to a first common variable X1 and a second common variable X2, respectively.

The natural language understanding and solving method provided by the present application may proceed with those formulas with single one variable and substitute the value of the variable into all formulas containing the variable. After that, new version of formulas with one less variable are generated accordingly. Or new formulas with single one variable may be generated. Next, it recursively substitutes the value of the single one variable into formulas with common variable. Eventually, the value of the variable in the question sentence can be derived.

Based on the aforementioned algorithms, the mathematical questions can be categorized into three types in the present application.

First type, chained equations. By substituting the value of the single variable of those formulas with single one variable into other formulas recursively, the unknown values of the mathematical questions can be calculated eventually.

Second type, simultaneous equations. After all the values of the single variables of those formulas with single one variable are recursively substituted, some simultaneous equations are still remained unsolved. It usually uses elimination method to solve the simultaneous equations. Person having ordinary skill in the art can understand that the elimination method to solve the simultaneous equation is well-known. Variables with unknown values in the simultaneous equations are recursively eliminated until only one variable remains. Thus, the value of the remained variable can be calculated accordingly. In the end, unknown values of the rest of the variables can be calculated based on the solving method for the chained equations.

Third type, no solution. The conditions are contradictory. Or the conditions are insufficient to calculate the unknown values of the mathematical questions. Those which cannot be categorized into the chained equations and the simultaneous equations belongs to this type.

### Examples of Calculations of Answers

Example: There are 22 cups of milk. Each person is assigned with 2 cups. Six cups are unassigned. How many people are assigned?

Analysis of each sentence.
(1) There are 22 cups of milk.
Quantity of cups of milk X1=22—Formula One
(2) Each person is assigned with 2 cups.

This sentence implies following two meanings. They are called entailments in the present application.

Entailment 1: Some milk is assigned to some people.
X2: Quantity of cups of milk is assigned to.
X3: Number of people is assigned with milk.
Entailment 2: Cups of milk assigned to each person=2

$$X 2 / X 3 = 2 - Formula Two$$

(3) Six cups are unassigned.
X4: Number of original cups of milk.
X5: Number of assigned cups of milk.

$$X 4 - X 5 = 6 - Formula Three$$

(4) How many people are assigned?
X6: Number of people are assigned.
X6=?, X6 is the variable of the mathematical question.

Next. Variable reduction is performed to integrate variables with different names but the same essence.
X6=X3 (hence, X3 is the variable of the mathematical question.)

$$X 4 = X 1.$$

$$X 5 = X 2.$$

Therefore, the derived formulas are listed below:

$$X 1 = 22 \qquad Formula One$$

$$X 2 / X 3 = 2 \qquad Formula Two$$

$$X 1 / X 2 = 6 \qquad Formula {Three}^{′}$$

Substitute the value of the variable X1 in Formula One into Formula Three'. X2=X1 (22)−6=16.

Substitute the value of the variable X2 in Formula Three' into Formula Two. X3=X2 (16)/2=8.

### 4. Generation of Explanation

In order to train students to have the ability to think logically: when facing the questions raised by students, it does not directly give answers or explanations (to avoid homework plagiarism). Instead, a similar question is found in a question bank (may include thousands of exemplary questions) and explanations are given to student. After students understand it, they can use their own words to answer the questions at hand.

The method of answer calculations is based on variable reduction/substitution on formula relation map. However, the method is designed to adapt to internal computations in a computer. When the values of variables are calculated, it needs to be explained to student in a way that can easily stimulate thinking. Reference books usually provide student with explanations in a straightforward manner. But after the books are closed, it is difficult to recall the solutions provided in the books.

The principle of the present application is goal oriented. Beginning with the formulas of the question sentence, unknown values of variables appeared in the mathematical question are calculated step by step. As discussed, the question sentence determines the last operation of the mathematical question is one of addition, subtraction, multiplication, division, or equivalence. When the formula derived from the question sentence is related “equivalence”, the goal is set to find the value of a variable. In addition, the formulas of the question sentence may be a multi-variable linear equation. The natural language understanding and solving method provided by the present application can set the goal as finding values of the variables in this multi-variable linear equation. Thus, condition sentences are utilized to recursively explain how to find out the values of each variable.

In the process of converting formula sentences into formulas, a standardized explanation can be given for each type of formula conversion (in other words, more than one explanation may be given.) And this sort of explanation can be applied to almost all situations involved with the kind of formula sentence. Next, for chained or simultaneous equations, each step mostly involves substituting the known values of variables into the formulas with unknown variable values to find out the unknown variable values. It is also relatively easy to explain.

Following example reuses the aforementioned milk question to described how to generate explanations.

Questions 1: (1) There are 22 cups of milk. (2) Each person is assigned with 2 cups. (3) Six cups are unassigned. (4) How many people are assigned?

Variables and related formulas are listed at first:
X1: Quantity of cups of milk
X2: Quantity of cups of milk is assigned to.
X3: Number of people is assigned with milk.

$$X 1 = 22. \qquad Formula One$$

$$X 2 / X 3 = 2 \qquad Formula Two$$

$$X 1 - X 2 = 6 \qquad Formula {Three}^{′}$$

$$X = 3 \qquad Formula Four$$

Based on the question sentence (4), it is required to know the number of people is assigned with milk.

Based on Formula Two, it is required to know the quantity of cups of milk is assigned to.

Based on sentence (1), it knows that the quantity of cups of milk X1 is 22. And based on sentence (3), it tells that six cups of milk are unassigned.

Therefore, based on Formula Three′, (the quantity of cups of milk is assigned to) X2=X1−6=22−6=16 cups.

Based on sentence (2), it tells that each person is assigned with 2 cups of milk. So according to Formula Two, (the number of people is assigned with milk) X3=X2/2=16/2=8.

Based on the explanations above, the question 1 can be categorized as type 1, chained equations. Following question is an example of simultaneous equations.

Question 2: (1) There are ten chickens and rabbit in a cage. (2) There are 30 legs. (3) How many chickens are in the cage? (4) How many rabbits in the cage?
X1: number of chickens.
X2: number of rabbits.

Analysis of each sentence:
(1) There are ten chickens and rabbit in a cage. Thus,

$$X 1 + X 2 = 10 \qquad Formula ( 11 )$$

A chicken has two legs. A rabbit has four legs. Thus,

$$2 X 1 + 4 X 2 = 30 \qquad Formula ( 12 )$$

There is no formula with single one variable. Each formula has two or more variables. Thus, this question is a type of simultaneous equations. Variable elimination method can be applied to calculate the answer.

Multiplies 2 to each side of Formula (11). It becomes 2 X1+2X2=20.

Subtract the derived Formula (11) from Formula (12). It becomes 2 X2=10. Thus, X2=5.

Then the value of the variable X2 is substituted into Formula (11), it finds that X1=5.

### Interactive and Personalized Test System

Learning mathematics requires continuous problem solving to master it thoughtfully. When students encounter difficulties in doing homework, timely help is most effective for them. These difficulties include 1. Not understanding the semantics of the context; 2. The logic connections between the preceding and following sentences is unclear; and 3. Calculation errors.

The natural language understanding and solving method provided by the present application designs a method of teaching through testing. It is designed to explore the questions through interactive dialogue. Instead of passively reading the explanations, students need to actively think and response questions. Followings are two examples, in which the provided system asks students questions, and the answers to these questions are shown after the students respond.

Questions 1: (1) There are 22 cups of milk. (2) Each person is assigned with 2 cups. (3) Six cups are unassigned. (4) How many people are assigned?
System: what is the meaning of “each person is assigned with 2 cups?”
Student: Two cups of milk are assigned to each one of people.
System: are all cups of milk assigned?
Student: No.
System: Six cups are unassigned means that there are six unassigned cups. How many cups of milk are assigned to?
Student: 22−6=16 cups.
System: based on the sentence (2), how many people are assigned?
Student: 16/2=8 people.

Question 3: (1) The father gives Hsiaoming 100 dollars; (2) He will have enough money to buy a bicycle; (3) if the price of the bicycle is 3000 dollars; (4) how much does Hsiaoming has?
System: who is “he” in the sentence (2)?
Student: Hsiaoming.
System: why is “he” not the father?
Student: because based on the sentence (2), “he” has insufficient money and his money increased to 300 dollars he needs. The sentence (1) tells that Hsiaoming's money has increased. Thus, “he” is Hsiaoming.
System: what formula does the sentence (2) derive?
Student: original money +increased money=money required (3000 dollars according to the sentence (3).)
System: how much money does Hsiaoming has originally?
Student: 3000−100=2900 dollars

### 5. Automatic Error Detection

After the answer is calculated, the natural language understanding and solving method provided by the present application further provides a process of automatic error detection. By aforementioned formula relationship map, the unknown values of variables listed according to the mathematical questions can be derived accordingly. Hence, the natural language understanding and solving method provided by the present application can further substitute these known values into the condition sentences to verify them. In such way, it can show whether the calculations are contradictory or not. If not contradictory, the correctness likelihood of the answers to the mathematical question is high.

If it shows contradictory, it may try to find out wrong formula sentences in next step. Assuming that there is only one wrong formula sentence, it can be detected. After the wrong formula sentence is found, it can further find out which one of formula conversion or the value substitution went wrong.

### 6. Knowledge Graph

The present application expands the traditional ontology to generalized ontology. It means that some related events of common senses are expanded to main concepts of traditional ontology. The natural language understanding and solving method provided by the present application places the common senses into main concepts of traditional ontology, for examples, entailments and inferences etc. are expanded as related events into corresponding verb concepts of traditional ontology. Tagged training corpus are stored in a “tagged database”, such as types of formula sentences, converted formulas, sentences for explaining examples (to help natural language generation), alternative equivalent sentences, and logics for creating interactive dialogues (to automatically generate testing questions and answers) etc. The natural language understanding and solving method provided by the present application highly integrates with the knowledge graph and training corpus to fulfill the requirements of explainable and trustable.

Following are a flow chart of a solving method for mathematical question in accordance with an embodiment of the present application.
First. refilling the omitted part in sentences of the mathematical question.
Second. finding correct person or objects corresponding to the demonstrative pronouns.
Third. performing necessary semantic inferences to list corresponding variables.
Fourth. converting each formula sentence into corresponding formula according to its type and corresponding pattern.
Fifth. unification of variables with different names but the same essence (variable reduction).
Sixth. establishing formula relationship map. Recursively substituting formula with single one variable into formula with multi-variables and calculating value of variables in the question sentence.
Seventh. beginning with the formula corresponding to the question sentence, recursively explaining how to determine the unknown values of each variable.
Eighth. testing students' understanding of the question through interactive dialogue.
Nineth. performing automatic error detection to avoid non-sense errors.
Tenth. storing common senses in the knowledge graph and storing training corpus in the tagged database.

Besides, for the mathematical question with one or more graphs, it may need to perform image processing to recognize the shapes and numbers denotes length of edges and solve the mathematical question with the text part. Follow on processes are already described above.

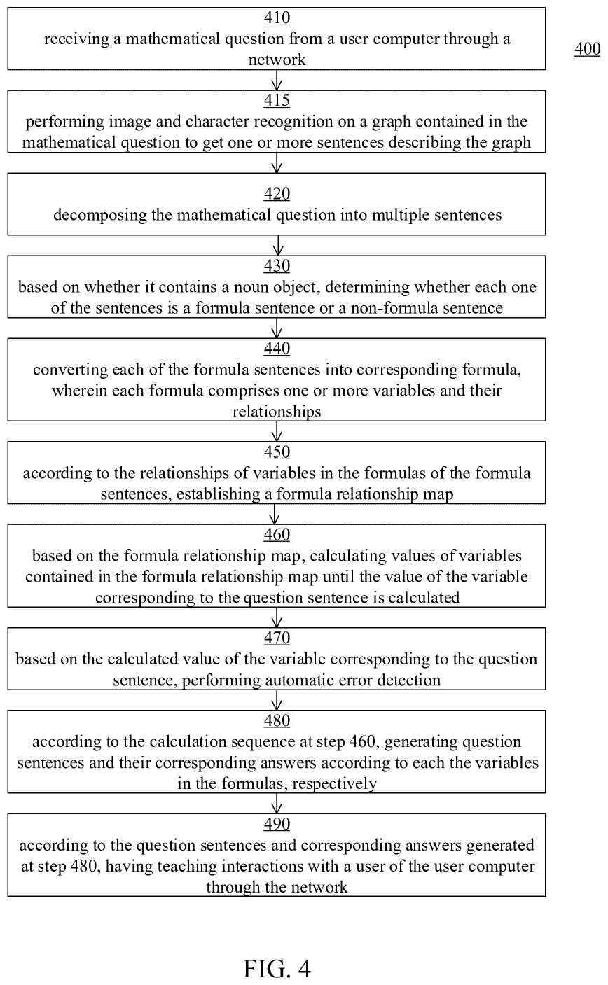

Please refer to FIG. 4, which illustrates a flowchart diagram of a method 400 for machine solving mathematical question in accordance with an embodiment of the present application. The method 400 can be applied to the server 100 as shown in FIGS. 1 and 2. The method 400 may be implemented as instructions and data stored in non-volatile memory. The server 110 executes the instructions to realize the method 400 for machine solving mathematical question. If there is no direct or indirect causal relationship between two steps, the present application does not limit the execution precedence of these two steps. The method 400 may begin with step 410.

Step 410: receiving a mathematical question from a user computer through a network, wherein the mathematical question comprises multiple sentences written in natural language, wherein the multiple sentences include at least one question sentence.

Optional step 415: performing image and character recognition on a graph contained in the mathematical question to get one or more sentences describing the graph.

Step 420: decomposing the mathematical question into multiple sentences.

Step 430: based on whether it contains a noun object, determining whether each one of the sentences is a formula sentence or a non-formula sentence (e.g., the scenic sentence). The noun object has a quantity modifier in its corresponding sentence.

Step 440: converting each of the formula sentences into corresponding formula, wherein each formula comprises one or more variables and their relationships.

Step 450: according to the relationships of variables in the formulas of the formula sentences, establishing a formula relationship map. The formula relationship may comprise one or more tree structures. The multiple tree structures may be referred to as a forest structure.

Step 460: based on the formula relationship map, calculating values of variables contained in the formula relationship map until the value of the variable corresponding to the question sentence is calculated.

Optional step 470: based on the calculated value of the variable corresponding to the question sentence, performing automatic error detection. Based on the formula relationship map, the calculated value of the variable corresponding to the question sentence and other values of the variables are recursively used to verify whether the corresponding formulas in their adjacent nodes are satisfied. If all formulas of each node are satisfied, the answer is determined correct. However, if there exists a node which has an unsatisfied formula, the answer is determined wrong.

Optional step 480: according to the calculation sequence at step 460, generating question sentences and their corresponding answers according to each the variables in the formulas, respectively. The corresponding answer to the question sentence is corresponding to the value of the variable.

Optional step 490: according to the question sentences and corresponding answers generated at step 480, having teaching interactions with a user of the user computer through the network.

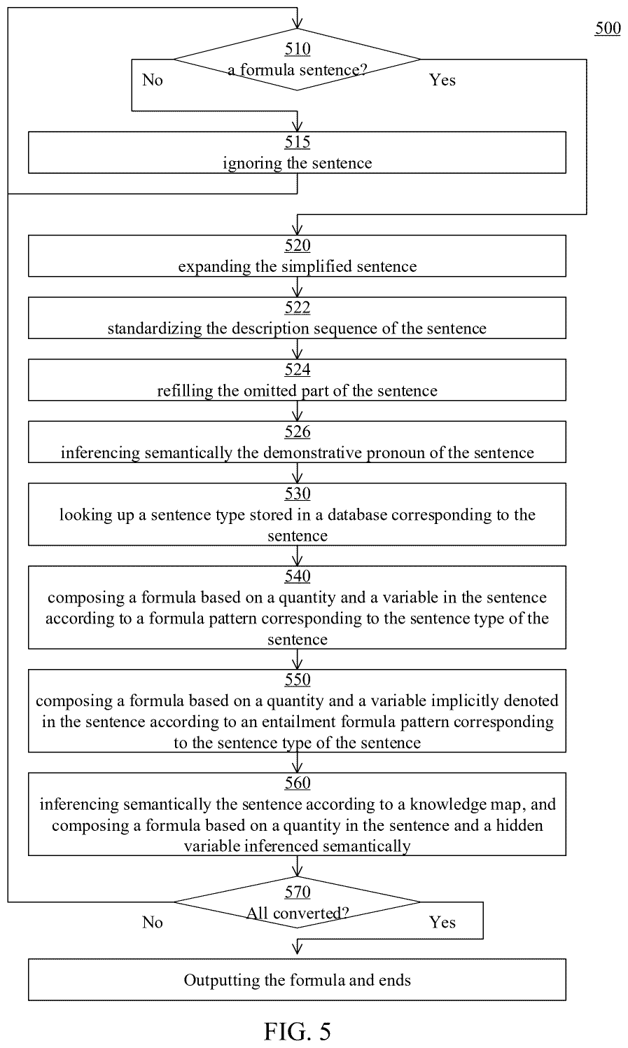

Please refer to FIG. 5, which illustrates a flowchart diagram of a method 500 for converting sentences into formulas in accordance with an embodiment of the present application. The method 500 may be an embodiment of the step 440 of the method 400 for machine solving mathematical question as shown in FIG. 4. The implementations of the method 500 may be identical to the implementation of the method 400. If there is no direct or indirect causal relationship between two steps, the present application does not limit the execution precedence of these two steps. The method 500 may begin with step 510.

Step 510: determining whether one of the multiple sentences is a formula sentence. When the sentence is a non-formula sentence, the flow proceeds to step 515. When the sentence is determined as a formula sentence, the flow proceeds to step 520.

Step 515: ignoring the sentence, the flow returns to step 510.

Step 520: expanding the simplified sentence. According to two or more relationships involved in the sentence, expanding the sentence into two or more sentences. For example, Hsiaoming buys two apples, three pineapples and a handful of lychees. This sentence can be expanded to three sentences: Hsiaoming buys two apples; Hsiaoming buys three pineapples; and Hsiaoming buys a handful of lychees. In one embodiment, a compound question sentence may be expanded into multiple Sub-Questions, each Sub-Question is with single variable. For example, the question sentence, “how many apples do A and B have,” can be expanded into “how many apples does A have?” and “how many apples does B have?”

Optional step 522: standardizing the description sequence of the sentence. For example, reforming the sentence into a standard structure such as Subject, Verb, and Object.

Optional step 524: refilling the omitted part of the sentence. As discussed above, the subject may be omitted in the sentence. The omitted subject and noun of the sentence may be determined according to the verb and local noun in the standard structure. Or the omitted noun in the sentence may be refilled according to the quantifiers such as seats and cups etc.

Optional step 526: inferencing semantically the demonstrative pronoun of the sentence. In one embodiment, person having ordinary skill in the art can understand that the step may use trained neural network models to inference the demonstrative pronoun in the sentence in order to find out which noun in which sentence in the mathematical question is referred to by the demonstrative pronoun. For example, a modern LLM (large language model) may provide a noun the demonstrative pronoun referred to among thousands of tokens preceding or succeeding the demonstrative pronoun.

Step 530: looking up a sentence type stored in a database corresponding to the sentence. The database stores multiple sentence types. In one embodiment, person having ordinary skill in the art can understand that the step may use trained neural network model to classify the sentence. The trained neural network model has a classifier to classify the sentence according to its sentence type. In an alternative embodiment, it may use a parser to interpret and to correct the sentence. Afterwards, the interpreted and corrected sentence is input into the LLM for classification.

In one embodiment, the step 530 may further comprise determining whether the sentence is a question sentence. The understanding of the question sentence is decisive for problem solve as well as self-debugging.

Step 540: composing a formula based on a quantity and a variable in the sentence according to a formula pattern corresponding to the sentence type of the sentence.

Optional step 550: composing a formula based on a quantity and a variable implicitly denoted in the sentence according to an entailment formula pattern corresponding to the sentence type of the sentence.

Optional step 560: inferencing semantically the sentence according to a knowledge map, and composing a formula based on a quantity in the sentence and a hidden variable inferenced semantically. For examples, in the knowledge map, there are many well-known types of questions, such as river current question, speed question, clock question, street light question. For these specific types of questions, there exists corresponding formulas. Hence, it may use trained neural network model to classify the sentence. The trained neural network model has a classifier to classify the sentence according to its well-known question type in the knowledge map. Furthermore, an implicit formula and a hidden variable corresponding to the question type can be determined. In an alternative embodiment, it may use a parser to interpret and to correct the sentence. Afterwards, the interpreted and corrected sentence is input into the LLM for classification.

The neural network models utilized in the steps 530 and 560 may be different. The neural network model utilized in the step 530 is configured to classify the sentence based on its sentence type. Therefore, a formula corresponding to the sentence type of the sentence can be found. The neural network model utilized in the step 560 is configured to classify the sentence based on its question type. Therefore a formula corresponding to the question type of the sentence can be found.

Step 570: determining whether all the formula sentences of the sentences in the mathematical question are all converted into formulas. If the result is negative, the flow returns to step 510. Otherwise, the flow ends. The output of the method 500 are formulas.

Returning to the step 450 as shown in FIG. 4, when there are multiple formulas, a formula relationship map, i.e., a graph structure defined in mathematics, can be formed based on relations between variables denoted in formulas of each formula sentences. The formula relationship map may include one or more tree structures. The multiple tree structures may be called as a forest structure. Each node of the tree structure or the forest structure corresponds to one of the formulas. Each formula may include one or more variables. Thus, the formula may be a single-variable formula or a multi-variable formula. If two nodes share a common variable, an edge is configured to connect these two nodes. And this edge is corresponding to the common variable. If two nodes share more than one common variables, two or more edges are used to connect these two nodes.

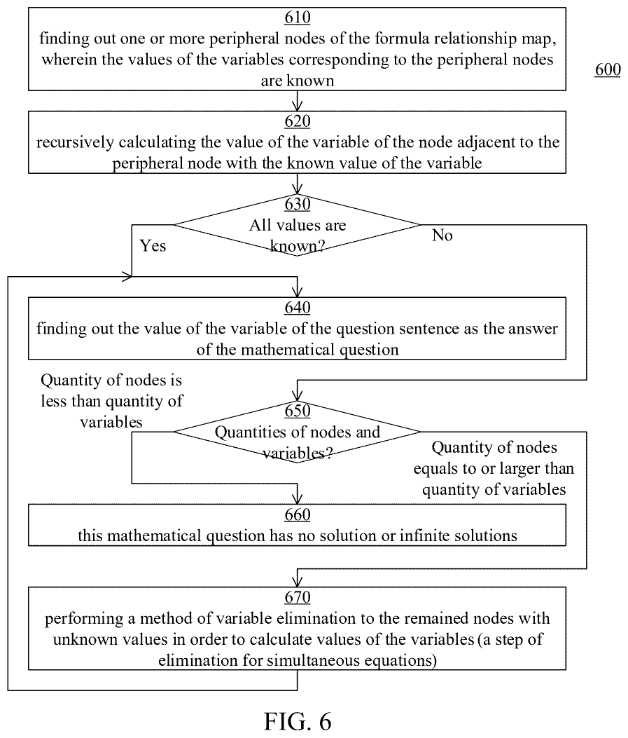

In the step 460 as shown in FIG. 4, when performing calculations on the formula relationship map, following steps may be required. Please refer to FIG. 6, which depicts a flowchart diagram of a solving method 600 on the formula relationship map in accordance with an embodiment of the present application. The solving method 600 on the formula relationship map may be an embodiment of the step 460 as shown in FIG. 4. The implementations of the solving method 600 on the formula relationship map and the method 400 for machine solving mathematical question may be similar. If there is no direct or indirect causal relationship between two steps, the present application does not limit the execution precedence of these two steps. The solving method 600 on the formula relationship map may begin with step 610.

Step 610: finding out one or more peripheral nodes of the formula relationship map, wherein the values of the variables corresponding to the peripheral nodes are known.

Step 620: recursively calculating the value of the variable of the node adjacent to the peripheral node with the known value of the variable.

Step 630: determining whether all values of the variables of all nodes in the formula relationship map are calculated. If so, the flow proceeds to step 640. Otherwise, the flow proceeds to step 650.

Step 640: finding out the value of the variable of the question sentence as the answer of the mathematical question. The flow ends here.

Step 650: determining how many nodes with unknown values and how many variables with unknown values. The nodes with unknown values must be multi-variable nodes. Assuming that there are N nodes with unknown values and M variables with unknown values, the flow proceeds to step 660 if M>N, where M and N are positive integers, respectively. If M<=N, the flow proceeds to step 670.

Step 660: Because the number M of variables is larger than the number N of nodes, it is unable to solve values of all nodes. Therefore, this mathematical question has no solution or infinite solutions.

Step 670: performing a method of variable elimination to the remained nodes with unknown values in order to calculate values of the variables. Next, the flow proceeds to step 640.

In summarized, the present application provides a method of machine solving and explaining mathematical questions. Unlike traditional large natural language models that make blind guesses at solving problems based on learned materials, this application provides an interpretable and reliable method. The focus is on interpreting mathematical problems into equations through a series of analysis, reasoning, and the infusion of common sense, and then calculating the final answer. Afterwards, explanations are provided in a “goal-oriented” manner and an interactive, personalized test system is produced. As the question types of the knowledge graph and sentence types expand, the automatic machine solving and explaining methods provided by this application can expand the range of problems it can solve. While the range of the problems is expanded, a series of heuristic questions and corresponding answers can still be put forward for the problem-solving process, so that students can understand the problem-solving process through step-by-step questions and answers.

According to an embodiment of the present application, a method of machine solving mathematical question is provided. The method is applicable to a server. The method comprises: receiving a mathematical question described in a natural language; decomposing the mathematical question into multiple sentences, wherein the multiple sentences include one question sentence; determining whether each of the sentences is a formula sentence based on whether it includes a noun subject; converting each of the formula sentences into a corresponding formula, respectively, wherein each of the formulas includes one or more variables and one or more relations of the one or more variables, respectively; establishing a formula relationship map according to the one or more relations of the one or more variables included each of the formulas; and calculating, sequentially, values of the one or more variables according to the formula relationship map until a value of the variable included in the formula of the question sentence is calculated as an answer.

Preferably, in order to automatic error detection, the method further comprises determining whether each of the formulas is satisfied according to the value of the variables included in the formula relationship map; and determining the answer is wrong when at least one of the formulas is no satisfied.

Preferably, in order to heuristically teaching, the method further comprises generating a corresponding question sentence and its answer according to the variable and its value included in each of the formulas; and interacting with a student via an input device and an output device of the server according to the corresponding question sentences and the answers.

Preferably, in order to cope with the mathematical question with one or more graph, the method further comprises performing image and character recognition to a graph of the mathematical question to generate one or more sentences for describing the graph in the natural language.

Preferably, in order to avoid error in solving due to missing formula, the method further comprises, before the converting, expanding a simplified one of the formula sentences to a plurality of formula sentences.

Preferably, in order to avoid error in converting the formula sentences into formulas such that the standard structure can be correctly mapped into the formula pattern, the method further comprises, before the converting, organizing one of the formula sentences into a standard structure, which includes a subject, a verb, and an object.

Preferably, in order to avoid error in converting the formula sentences into formulas such that the standard structure can be correctly mapped into the formula pattern, the method further comprises, before the converting, refilling an omitted part in one of the formula sentences.

Preferably, in order to avoid error in converting the formula sentences into formulas, the method further comprises, before the converting, inferencing a noun referred by a demonstrative pronoun in one of the formula sentences.

Preferably, in order to make use of well-known correspondences between the formula sentences and the formulas, the converting further comprises looking up one of sentence types corresponding to one of the formula sentences in a database, wherein the database includes information of the sentence types; and composing the corresponding formula based on a quantity and a variable in the one of the formula sentences according to a formula pattern corresponding to the one of the sentence types corresponding to the one of the formula sentences.

Preferably, in order to make use of well-known correspondences between the formula sentences and one or more entailment formulas, the converting further comprises composing the corresponding formula based on the quantity and the variable implicitly denoted in the one of the formula sentences according to an entailment formula pattern corresponding to the one of the sentence types corresponding to the one of the formula sentences.

Preferably, in order to cope with ever changing expressions of sentences, the method further comprises classifying the one of the formula sentences according to a trained neural network model for looking up the one of the sentence types corresponding to the one of the formula sentences.

Preferably, in order to take advantage of hidden knowledge and to avoid missing formula, the converting further comprises inferencing semantically one of the formula sentences according to a knowledge map; and composing the corresponding formula based on a quantity included in the one of the formula sentences and a hidden variable inferenced semantically.

Preferably, Preferably, in order to cope with ever changing expressions of sentences, the method further comprises classifying the one of the formula sentences according to a trained neural network model for finding out a question type of the one of the formula sentences to get an implicit formula and the hidden variable corresponding to the question type.

Preferably, in order to make relationships between formulas, the establishing further comprises unifying all of the variables with same essence to reduce a quantity of variables; and connecting nodes of the formula relationship map with an edge referred to a common one of the variables, wherein the connected nodes are corresponding to the formula sentences including the common one of the variables, respectively.

Preferably, in order to solving mathematical question with chained equations, the calculating further comprises finding out one or more peripheral formulas of the formula relationship map, wherein the value of the variable corresponding to the peripheral formula is known; and recursively calculating the value of the variable of the formula adjacent to the formula including the calculated value of the variable.

Preferably, in order to solving mathematical question with simultaneous equations, the calculating further comprises, after the recursively calculating, when at least one value of the variables included in the formula relationship map is unknown, performing a step of variable elimination to solve simultaneous equations to calculate all values of the variables included in the relationship map of formula.

According to one embodiment of the present application, a server of machine solving mathematical question is provided. The server comprises a processor configured for executing multiple instructions stored in a non-volatile memory to fulfill the method recited above.

Preferably, in order to perform machine solving in a single machine, the server further comprises an input device for receiving the mathematical question; and an output device for outputting the answer.

Preferably, in order to perform machine solving in a network environment, a system of machine solving mathematical question is provided according to an embodiment of the present application. The system comprises the server as recited above; and a user computer, configured for transmitting the mathematical question to the server via a network and for receiving the answer from the server via the network.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method of machine solving mathematical question, wherein the method is applicable to a server, wherein the method comprising:
receiving a mathematical question described in a natural language;
decomposing the mathematical question into multiple sentences, wherein the multiple sentences include one question sentence;
determining whether each of the sentences is a formula sentence based on whether it includes a noun subject;
converting each of the formula sentences into a corresponding formula, respectively, wherein each of the formulas includes one or more variables and one or more relations of the one or more variables, respectively;
establishing a formula relationship map according to the one or more relations of the one or more variables included each of the formulas; and
calculating, sequentially, values of the one or more variables according to the formula relationship map until a value of the variable included in the formula of the question sentence is calculated as an answer.

2. The method of claim 1, further comprises:
determining whether each of the formulas is satisfied according to the value of the variables included in the formula relationship map; and
determining the answer is wrong when at least one of the formulas is no satisfied.

3. The method of claim 1, further comprises:
generating a corresponding question sentence and its answer according to the variable and its value included in each of the formulas; and
interacting with a student via an input device and an output device of the server according to the corresponding question sentences and the answers.

4. The method of claim 1, further comprises:
after the receiving, performing image and character recognition to a graph of the mathematical question to generate one or more sentences for describing the graph in the natural language.

5. The method of claim 1, further comprises:
before the converting, expanding a simplified one of the formula sentences to a plurality of formula sentences.

6. The method of claim 1, further comprises:
before the converting, organizing one of the formula sentences into a standard structure, which includes a subject, a verb, and an object.

7. The method of claim 1, further comprises:
before the converting, refilling an omitted part in one of the formula sentences.

8. The method of claim 1, further comprises:
before the converting, inferencing a noun referred by a demonstrative pronoun in one of the formula sentences.

9. The method of claim 1, wherein the converting further comprises:
looking up one of sentence types corresponding to one of the formula sentences in a database, wherein the database includes information of the sentence types; and
composing the corresponding formula based on a quantity and a variable in the one of the formula sentences according to a formula pattern corresponding to the one of the sentence types corresponding to the one of the formula sentences.

10. The method of claim 9, wherein the converting further comprises:
composing the corresponding formula based on the quantity and the variable implicitly denoted in the one of the formula sentences according to an entailment formula pattern corresponding to the one of the sentence types corresponding to the one of the formula sentences.

11. The method of claim 9, further comprises:
classifying the one of the formula sentences according to a trained neural network model for looking up the one of the sentence types corresponding to the one of the formula sentences.

12. The method of claim 1, wherein the converting further comprises:
inferencing semantically one of the formula sentences according to a knowledge map; and
composing the corresponding formula based on a quantity included in the one of the formula sentences and a hidden variable inferenced semantically.

13. The method of claim 12, further comprises:
classifying the one of the formula sentences according to a trained neural network model for finding out a question type of the one of the formula sentences to get an implicit formula and the hidden variable corresponding to the question type.

14. The method of claim 1, wherein the establishing further comprises:
unifying all of the variables with same essence to reduce a quantity of variables; and
connecting nodes of the formula relationship map with an edge referred to a common one of the variables, wherein the connected nodes are corresponding to the formula sentences including the common one of the variables, respectively.

15. The method of claim 1, wherein the calculating further comprises:
finding out one or more peripheral formulas of the formula relationship map, wherein the value of the variable corresponding to the peripheral formula is known; and
recursively calculating the value of the variable of the formula adjacent to the formula including the calculated value of the variable.

16. The method of claim 15, further comprises:
after the recursively calculating, when at least one value of the variables included in the formula relationship map is unknown, performing a step of variable elimination to solve simultaneous equations to calculate all values of the variables included in the formula relationship map.

17. A server of machine solving mathematical question, comprising a processor configured for executing multiple instructions stored in a non-volatile memory to fulfill the method recited in claim 1.

18. The server of claim 17, further comprises:
an input device for receiving the mathematical question; and
an output device for outputting the answer.

19. A system of machine solving mathematical question, comprising:
the server recited in claim 17; and
a user computer, configured for transmitting the mathematical question to the server via a network and for receiving the answer from the server via the network.
